(19) United States
(12) Patent Application Publication
(10) Pub. No.: US 2008/0304403 A1
(43) Pub. Date: Dec. 11, 2008

(54) METHOD AND SYSTEM FOR DIVERSITY RECEIVER BASED ON TDS-OFDM TECHNOLOGY

(75) Inventors: YAN ZHONG, SAN JOSE, CA (US); HAIYUN YANG, SAN JOSE, CA (US)

Correspondence Address: FRANK F. TIAN, 331-4A THIRD AVENUE, LONG BEACH, NJ, 07740, US

(73) Assignee: LEGEND SILICON, FREMONT, CA (US)

(21) Appl. No.: 11/760,724

(22) Filed: Jun. 8, 2007

(51) Int. Cl. H04J 11/00

(52) U.S. Cl. 370/203

(57) ABSTRACT

A method for selecting parameter comprising the steps of: providing a plurality of paths each path associated with an independent antenna, and each path comprising: a set of parameters associated with a particular channel; and deriving a parameter among each and every of the set of parameters associated with a particular channel. The method further comprises the step of providing a time de-interleaver or FEC decoder shared by the plurality of paths.

### CROSS-REFERENCE TO OTHER APPLICATIONS

The following applications of common assignee are related to the present application, and are herein incorporated by reference in their entireties:

U.S. patent application Ser. No. 11/550,316 to Liu et al, entitled “A METHOD AND DEVICE FOR FREQUENCY DOMAIN COMPENSATION FOR CHANNEL ESTIMATION AT AN OVER SAMPING REATE IN A TDS-OFDM RECEIVER” with attorney docket number LSFFT-018.

U.S. patent application Ser. No. 11/677,225 to Zhong, entitled “TIME DE-INTERLEAVER IMPLEMENTATION USING SDRAM IN A TDS-OFDM RECEIVER” with attorney docket number LSFFT-032.

U.S. patent application Ser. No. 11/550,505 to Zhong, entitled “METHOD FOR FORMING A BIT LOG-LIKELIHOOD RATIO FROM SYMBOL LOG-LIKELIHOOD RATIO” with attorney docket number LSFFT-022, which is hereby incorporated herein by reference.

### FIELD OF THE INVENTION

The present invention relates generally to a diversity system, more specifically the present invention relates to a mobile broadcast reception system used for the reception of broadcast signals.

### BACKGROUND

Digital broadcast nowadays include terrestrial broadcast televisions, which further includes OFDM receivers and the like. Because of multi-path effect, diversity system having different reception antennae may be required. To achieve quality reception similar to reception achieved in a stationary home or work environment, diversity reception antennae may be employed in mobile broadcast reception systems. Diversity reception generally implies spatial diversity. Another method that may be used is cross-polarization diversity, which may address problems associated with restricted space in the mobile broadcast reception systems.

As can be seen, a disadvantage with current diversity as employed in mobile reception systems is time varying multi-path fading. Different multi-path intensity profiles exist for a mobile reception system. Multi-path fading may arise in wireless broadcast as a result of reflections from stationary and non-stationary objects. Multi-path fading is manifested as a random amplitude and phase modulation. At a receiver side, multiple copies of a signal are summed together in either a constructive, or a destructive manner. The destructive addition of the signals may create fading dips in the signal power. The exact phase relationship, including the degree of cancellation, may vary from position to position, thereby making it possible for an antenna at a first location to experience severe destructive cancellation and an antenna at a second location to experience constructive addition.

Diversity techniques aim to improve reception performance by allowing more than one antenna to be used with a common receiver. These antennae may be spatially separated by an appropriate distance or have different polarizations. Thus, selecting the best antenna on a dynamic basis provides some operational advantage such as automatically and dynamically recovering the highest possible signal quality.

Multi-path fading is especially an issue in orthogonal frequency division multiplexing (OFDM) as generally utilized in digital video broadcast (DVB). OFDM is a method of digital modulation in which a signal is split into narrowband channels at different frequencies. In some respects, OFDM is similar to conventional frequency-division multiplexing (FDM). The difference, however, lies in how the signals are modulated and demodulated. Priority is given to minimizing the interference (crosstalk) among a set of symbols making up the data stream. In other words, less importance is placed on perfecting individual channels. Thus, a typical multi-path fading environment may include a signal transmitted from a transmitter received by a receiver mounted in, for example, a vehicle or a hand-held mobile station. In this situation, the signal transmitted may be received directly by the receiver, as well as after having been reflected off various objects in the surrounding environment such as buildings and/or trees. These different signals received are not correlated. However, for many scattering environments, spatial diversity is an effective way to improve the performance of wireless radio systems. The signals (at least two) should be received by the diversity antennae and then switched between or combined in the receiver. For the mobile DTV receiver, to achieve a reliable reception, a few functions block, such as signal tracking, channel estimation, equalizer and FEC decoder must be carefully designed. But no matter how these functional block are well designed, there are always some cases where the reception is not reliable. other ways to improve upon the reception includes the use of multiple antennae, which is usually referred as a diversity system.

In a diversity system, there are always two or more antennae with each antenna associated with an input signal or path, the input signal to each path is processed independently at first, and then at a predetermined location down stream the two or more processed signals are combined as a single one information stream and sent to the next block, such as MPEG-2 decoder. There are typically some issues or questions to be answered in this process. For example, at which point, the two or more than two independent signals will be combined? In addition, in order to achieve the most reliable reception, how these two or more than two signals are combined? Therefore, a solution of the diversity system based on TDS-OFDM for at least two antennae is provided to solve these two issues or questions.

### SUMMARY OF THE INVENTION

A diversity system a method for selecting parameters based upon the conditions of various paths.

A method for selecting parameter comprising the steps of: providing a plurality of paths each path associated with an independent antenna, and each path comprising: a set of parameters associated with a particular channel; and deriving a parameter among each and every of the set of parameters associated with a particular channel. The method further comprising the step of providing a time de-interleaver or FEC decoder shared by the plurality of paths.

The present invention provides a solution to a diversity system based on TDS-OFDM with at least two antennae.

The present invention addresses the issue as to where the signals from the at least two antennae or paths can be combined into a single signal path.

The present invention also provides a practical solution as to how the at least two signals from different antennae can be combined.

The present invention not only can significantly improve the reception in the mobile situation, but also achieve a good balance between the performance and the implementation cost.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a single path TDS-OFDM receiver.

FIG. 2 is an example of a multi-path TDS-OFDM receiver in accordance with some embodiments of the invention.

FIG. 3 is an example of a selecting parameters in accordance with some embodiments of the invention.

FIG. 4 is an example of a flowchart in accordance with some embodiments of the invention.

FIG. 4A is an example of a diagram in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to selecting parameters based upon the conditions of various paths. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of selecting parameters based upon the conditions of various paths described herein. The non-processor circuits may include, but are not limited to, a radio receiver, a radio transmitter, signal drivers, clock circuits, power source circuits, and user input devices. As such, these functions may be interpreted as steps of a method to perform selecting parameters based upon the conditions of various paths. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

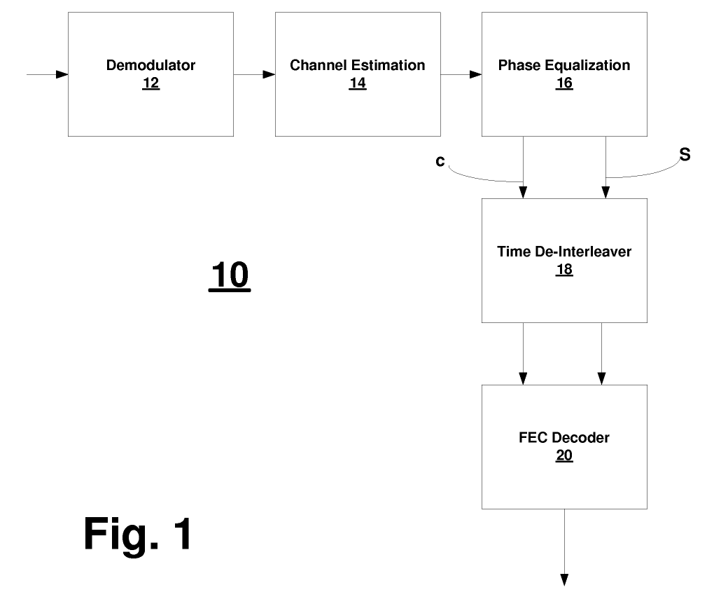

Referring to FIG. 1, a typical single path TDS-OFDM receiver 10 is shown. A signal is down-converted into the base band and goes through a demodulator 12 to demodulate a modulated symbol at a transmission end (not shown). The demodulated signal is subjected to a channel estimation block 14 for a estimation of a quality of a particular channel. The signal in turn passed through a phase equalization block 16. After phase equalization, two types of signals are generated. The signals are a received signal with phase equalized “S” and a magnitude of the estimated channel information “c”. Then, the signals including the phase equalized “S” and the magnitude of the estimated channel information “c” are de-interleaved together to overcome the deepfading or burst errors at combiner block 18. Alternatively, in switched diversity, one or the other of at least two antennae is selected and one of the antennae remains selected until the received signal strength falls below some limit of acceptability. In some cases, the signal further goes through a forward error correction (FEC) decoder. FIG. 1 presents a simplified block diagram of TDS-OFDM receiver. For a more comprehensive depiction of the receiver, see U.S. patent application Ser. No. 11/550,316 to Liu et al, entitled “A METHOD AND DEVICE FOR FREQUENCY DOMAIN COMPENSATION FOR CHANNEL ESTIMATION AT AN OVER SAMPING REATE IN A TDS-OFDM RECEIVER” with attorney docket number LSFFT-018, which is hereby incorporated herein by reference.

The phase equalization has two outputs, S and c, where S is the received signal with phase equalized, c is the magnitude of the estimated channel information. After time de-interleaver, these two signals are sent to FEC decoder. For a more comprehensive depiction of the FEC decoder, see U.S. patent application Ser. No. 11/677,225 to Zhong, entitled “TIME DE-INTERLEAVER IMPLEMENTATION USING SDRAM IN A TDS-OFDM RECEIVER” with attorney docket number LSFFT-032, which is hereby incorporated herein by reference. Furthermore, U.S. patent application Ser. No. 11/550,505 to Zhong, entitled “METHOD FOR FORMING A BIT LOG-LIKELIHOOD RATIO FROM SYMBOL LOG-LIKELIHOOD RATIO” with attorney docket number LSFFT-022, which is hereby incorporated herein by reference.

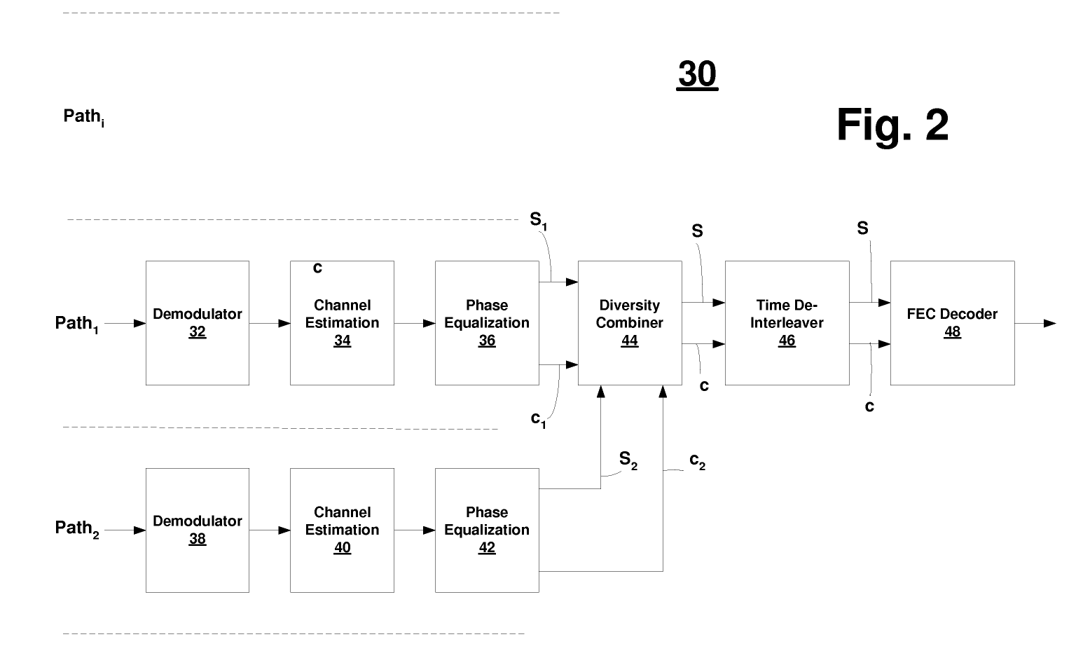

Referring to FIG. 2, a multi-path TDS-OFDM receiver 30 is shown. Receiver 30 comprises at least two paths, path₁ and path₂. In other words, receiver 30 may comprise a number ‘i’ of paths, where ‘i’ is a natural number that ranges from 1 to n with n being a natural number greater than or equal to 2. In path₁, a first signal is down-converted into the base band and goes through a demodulator 32 to demodulate a modulated symbol at a transmission end (not shown). The demodulated signal is subjected to a channel estimation block 34 for an estimation of a quality of a particular channel associated with path₁. The signal in turn passed through a phase equalization block 36. After phase equalization, two types of signals are generated. The signals are a received signal with phase equalized “S₁” and a magnitude of the estimated channel information “c₁”, both associated with the channel relating to path₁. Then, the signals including the phase equalized “S₁” and the magnitude of the estimated channel information “c₁” are combined to optimize the signal to noise ratio. Additionally, the “S₁” and “c₁” combination is further combine with another path or other path of receiver 30.

In path₂, a second signal is down-converted into the base band and goes through a demodulator 38 to demodulate a modulated symbol at a transmission end (not shown). The demodulated signal a channel estimation block 40 for an estimation of a quality of a particular channel. The signal in turn passed through a phase equalization block 42. After phase equalization, two types of signals are generated. The signals are a received signal with phase equalized “S₂” and a magnitude of the estimated channel information “c₂”. Then, the signals including the phase equalized “S₂” and the magnitude of the estimated channel information “c₂” are combined with the signals including the phase equalized “S₁” and the magnitude of the estimated channel information “c₁” are combined to optimize the signal to noise ratio to optimize the signal to noise ratio at diversity combiner 44 to optimize the signal to noise ratio. It is noted that further combinations with another path such as pathᵢ or other path of receiver 30 is contemplated by the present invention.

The combined signals including the phase equalized “S” and the magnitude of the estimated channel information “c” are combined to optimize the signal to noise ratio are de-interleaved at time de-interleaver 46. Alternatively, in switched diversity, one or the other of at least two antennae is selected and one of the antennae remains selected until the received signal strength falls below some limit of acceptability. In some cases, the signal further goes through a forward error correction (FEC) decoder 48.

In a DTV system, in order to achieve a reliable receiving performance a TDS-OFDM receiver for a mobile wireless broadband applications, no matter how the system is well designed there are always some cases where the reception is not stable. This is especially in the context of a mobile situation. One solution is to use multiple antennae, which is separated in the space, as shown in FIG. 2.

FIG. 2 presents a simplified block diagram of the receiver for the diversity system of the present invention. The at least two pairs of (S, c) are sent to the diversity combiner. After combination, the combined version of (S, c) is sent to the time de-interleaver. There are two reasons that the combiner is located between the phase equalizer and the time de-interleaver. First, before the combiner, each branch has its own demodulator, channel estimation and phase equalizer. Each path fully takes into consideration that each antenna may receive significantly different signals. Second, time de-interleaver needs about 0.91 mega words memory. This piece of memory is significant in size in that a big portion in a TDS-OFDM receiver. By combining the signals from two antennae, the combined signal will be processed in the same way as the single antenna path receiver. In other words, the diversity receiver of the present invention needs only one set of memory for the time de-interleaver.

One of the advantages of combining the paths at diversity combiner 44 is that time de-interleaver 46 typically requires a very large memory space for processing. Therefore, if each path is doing a separate de-interleaving, a let of memory space is required. As can be seen, it is advantageous to have a single or at least less number of de-interleaver in order to save memory space. As can be seen, a single FEC decoder is similarly advantageously used herein as well.

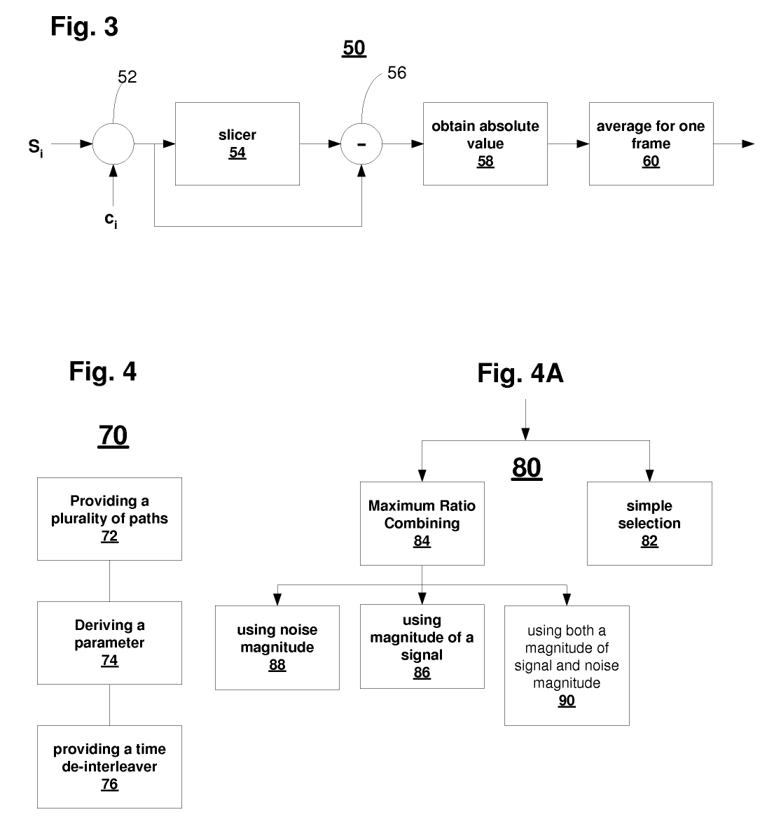

Referring to FIG. 3, a depiction 50 of getting Sᵢ and cᵢ is shown. Sᵢ and cᵢ are first subjected to a divider 52. The compared Sᵢ and cᵢ go through a slicer 54. The sliced Sᵢ and cᵢ are subjected to a subtraction action by subtractor 56 using the non-sliced Sᵢ and cᵢ. an absolute value of the difference is obtained by block 58. In turn, average on a per frame basis 60 is obtained.

The following depicts a selection process for Sᵢ and cᵢ. Initially, a threshold value is predetermined. Assuming there are only two paths, each path being associated with Sᵢ and cᵢ, i.e. S₁ and c₁ and S₂ and c₂ respectively. If the noise associated with the first path n₁ is significantly greater than the noise associated with the second path n₂, then the receiver uses only parameters from path₂. In other words, if n₁>n₂+threshold, select channel 2. On the other hand, if the noise associated with the first path n₂ is significantly greater than the noise associated with the second path n₁, then the receiver uses only parameters from path₁. In other words, if n₂>n₁+threshold, select channel 1.

However, if n₁ and n₂ are compatible or the noise levels of the two channels are compatible, the parameters from both channels are used for the determinations of S and c. Methods including Maximum Ratio Combining (MRC) is used to obtain the S and c. There are four methods all of which are listed below.

MRC is formularly described as follows.

In an exemplified 2 channel case,

$$S = \frac{{r}_{1} {S}_{1} + {r}_{2} {S}_{2}}{\sqrt{{r}_{1}^{2} + {r}_{2}^{2}}}$$

Where S is the combined or resultant signal. rᵢ is the signal noise ratio (SNR) of channel i. Sᵢ is the received signal with phase equalized for channel i.

Method I: Simple Selection. In a single frame such as a TDS-OFDM frame having 3780 symbols, the Sᵢ and cᵢ, are defined thereon. In other words, S₁(i) is defined on 0≦i≦3780; and c₁(i) is defined on 0≦i≦3780. Similarly S₂(i) is defined on 0≦i≦3780; and c₂(i) is defined on 0≦i≦3780. If c₁(i) is significantly larger than c₂(i), S₁(i)→S(i). On the other hand, if c₂(i) is significantly larger than c₁(i), S₂(i)→S(i).

For Methods II-IV, MRC is used.

Method II: wherein the magnitude of the signal is used and deemed predominant.

$$S ( i ) = \frac{{c}_{1} ( i ) \cdot {S}_{1} ( i ) + {c}_{2} ( i ) \cdot {S}_{2} ( i )}{\sqrt{{c}_{1}^{2} ( i ) + {c}_{2}^{2} ( i )}}$$

$$c ( i ) = \sqrt{{c}_{1}^{2} ( i ) + {c}_{2}^{2} ( i )}$$

Where c₁(i) is the magnitude of channel information 1 for segment i.

Where c₂(i) is the magnitude of channel information 2 for segment i.

Where c(i) is the averaged, estimated magnitude.

Where S₁(i) is the received signal of channel 1 with phase equalized for segment i.

Where S₂(i) is the received signal of channel 2 with phase equalized for segment i.

Where S(i) is the received signal with phase equalized for segment i.

Method III: wherein the noise magnitude of the signal is used and deemed predominant.

$$S ( i ) = \frac{\frac{1}{{n}_{1}} \cdot {S}_{1} ( i ) + \frac{1}{{n}_{2}} \cdot {S}_{2} ( i )}{\sqrt{\frac{1}{{n}_{1}^{2}} + \frac{1}{{n}_{2}^{2}}}} = \frac{{n}_{2} {S}_{1} ( i ) + {n}_{1} {S}_{2} ( i )}{\sqrt{( {n}_{1}^{2} + {n}_{2}^{2}}}$$

$$c ( i ) = \frac{{n}_{2} c ( i ) + {n}_{1} c ( i )}{\sqrt{( {n}_{1}^{2} + {n}_{2}^{2}}}$$

Where nᵢ is the estimated noise of channel i.

Where c(i) is the estimated magnitude.

Where S₁(i) is the magnitude or later determined magnitude of channel 1 for segment i.

Where S₂(i) is the magnitude or later determined magnitude of channel 2 for segment i.

Where S(i) is acquired or derived magnitude.

Method IV: wherein both the magnitude of signals and the noise magnitude of the signal are used and deemed predominant.

$$S ( i ) = \frac{\frac{{c}_{1} ( i )}{{n}_{1}} \cdot {S}_{1} ( i ) + \frac{{c}_{2} ( i )}{{n}_{2}} \cdot {S}_{2} ( i )}{\sqrt{{( \frac{{c}_{1} ( i )}{{n}_{1}} )}^{2} + {( \frac{{c}_{2} ( i )}{{n}_{2}} )}^{2}}}$$

$$c ( i ) = \frac{\frac{{c}_{1} ( i )}{{n}_{1}} + \frac{{c}_{2} ( i )}{{n}_{2}}}{\sqrt{{( \frac{{c}_{1} ( i )}{{n}_{1}} )}^{2} + {( \frac{{c}_{2} ( i )}{{n}_{2}} )}^{2}}}$$

Where nᵢ is the estimated noise of channel i.

Where c₁(i) is the magnitude of channel information 1 for segment i.

Where c₂(i) is the magnitude of channel information 2 for segment i.

Where c(i) is the averaged estimated magnitude.

Where S₁(i) is the magnitude or later determined magnitude of channel 1 for segment i.

Where S₂(i) is the magnitude or later determined magnitude of channel 2 for segment i.

Where S(i) is acquired or derived magnitude.

Referring to FIG. 4, a flowchart 70 of the present invention is shown. A method for selecting parameter is provided. The method comprises the following steps: provide a plurality of paths each path associated with an independent antenna, and each path comprising: a set of parameters associated with a particular channel (Step 72). The set of parameters comprises noise associated with channel i. They comprise Si and ci associated with channel i. More specifically, they comprise Si and ci associated with channel i within a predetermined time segment such as a symbol with a frame. The method further comprises the step of deriving a parameter among each and every of the set of parameters associated with a particular channel (Step 74). The method still further comprises the step of providing a time de-interleaver shared by the plurality of paths (Step 76). Similarly, a single FEC decoder is similarly advantageously used herein as well.

Referring to FIG. 4A, a diagram 80 depicting the derivative step of 74 in FIG. 4 is shown. The deriving step may comprise using simple selection, wherein only parameters from a single channel is used 82. Alternatively, the deriving step comprises using Maximum Ratio Combining (MRC), wherein parameters from a plurality of channels is used 84. The MRC may comprise using a magnitude of a signal 86. The MRC may comprise using a noise magnitude 88. The MRC may comprise using both a magnitude of a signal and a noise magnitude 90.

The present invention advantageously positions the time deinterleaver for such things as savings on memory. Additionally, MRC is present invention advantageously based on MRC for the determinations of phase-equalized S and csi with multiple variations. Furthermore, the present invention applies to a TDS-OFDM system.

The present invention contemplates its use in a Time Domain Synchronous-Orthogonal Frequency Division Multiplexing (TDS-OFDM) communication system. The frame structure of TDS-OFDM is as follows. One frame consists of PN sequences used as guard intervals interposed between data. The frame is positioned sequentially within a frame among a multiplicity of frames. As can be appreciated, PNs are disposed between the OFDM symbols. It is noted that the present invention contemplates using the PN sequence disclosed in U.S. Pat. No. 7,072,289 to Yang et al which is hereby incorporated herein by reference.

The present invention is directed to a diversity system with reduced number of memory consuming devices such as de-interleavers or FEC decoders, identification, and evaluation of antenna properties. In particular, this application is directed to a mobile broadcast reception system to be used for the reception of broadcast signals in a vehicle.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. A method for selecting parameter comprising the steps of:
providing a plurality of paths each path associated with an independent antenna, and each path comprising: a set of parameters associated with a particular channel; and
deriving a parameter among each and every of the set of parameters associated with a particular channel.

2. The method of claim 1 further comprising the step of providing a time de-interleaver shared by the plurality of paths.

3. The method of claim 1, wherein the deriving step comprises using simple selection, wherein only parameters from a single channel is used.

4. The method of claim 1, wherein the deriving step comprises using Maximum Ratio Combining (MRC), wherein parameters from a plurality of channels is used.

5. The method of claim 4, wherein the deriving step comprises using a magnitude of a signal.

6. The method of claim 4, wherein the deriving step comprises using a noise magnitude.

7. The method of claim 4, wherein the deriving step comprises using both a magnitude of a signal and a noise magnitude.

8. The method of claim 1, wherein the set of parameters comprises noise associated with channel i.

9. The method of claim 1, wherein the set of parameters comprises Si associated with channel i.

10. The method of claim 1, wherein the set of parameters comprises ci associated with channel i.

11. The method of claim 1, wherein the set of parameters comprises Si associated with channel i within a predetermined time segment.

12. The method of claim 1, wherein the set of parameters comprises ci associated with channel i within a predetermined time segment.

13. The method of claim 1 further comprising the step of providing a FEC decoder shared by the plurality of paths.
